(19) United States
(12) Patent Application Publication
(10) Pub. No.: US 2003/0231620 A1
(43) Pub. Date: Dec. 18, 2003

(54) Station equipment control system and station equipment

(75) Inventor: Tomonori Yasumoto, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/347,852

(22) Filed: Jan. 21, 2003

(30) Foreign Application Priority Data
Jun. 13, 2002 (JP) 2002-173166

(51) Int. Cl. H04L 12/66

(52) U.S. Cl. 370/352; 370/355

(57) ABSTRACT

A control system for an ADSL access multiplexer using an analog telephone signal that enables reset or changing a configuration setting of the DSLAM directly from customer premise equipment without involvement of an administrator company of the DSLAM, the system comprising customer premise equipment 1 that comprises an xDSL terminal 4 and an analog terminal 5 that produces DTMF sound, and station equipment 2 that is connected to the customer premise equipment via an analog line 7 and includes a telephone exchange 8 and the xDSL access multiplexer 9 for configuring xDSL communication conditions of each xDSL terminal, the telephone exchange comprising a controller 12 that makes various configuration settings of the DSLAM corresponding to each xDSL terminal changeable in response to a special number, in the form of DTMF sound, that is sent from the analog terminal.

### BACKGROUND OF THE INVENTION

1. Field of the Invention

The present invention relates to a control system for xDSL station premise equipment using an analog telephone signal and, in particular, it relates to a system for controlling xDSL station premise equipment that comprises a Digital Subscriber Line Access Multiplexer (DSLAM) by using an analog telephone signal from the terminal side through a telephone exchange.

2. Description of the Related Art

An xDSL operational mode may be configured variously. For example, G. lite Annex C and G. dmt Annex C standards are used in Japan, while Annex A standard is used in North America. G. lite Annex C includes FBM (Far End X(Cross) Talk BitMap) that does not feed data to the downlink transmission line but feeds data to the uplink transmission line only, and DBM (Dual BitMap) that transmits data slowly at the instant at which noise increases and transmits data rapidly at the instant at which noise decreases in synchronization with ISDN.

In any of such operational modes, it may be necessary to reset or change a configuration when, for example, abnormal conditions are detected at the terminal side.

Conventionally, only an administrator of the DSLAM could reset or change configuration such as an operational mode of the terminal corresponding to the DSLAM or line speed. Therefore, in order to change or reset any configuration setting of the DSLAM, it was necessary to make contact with the administrator company of the DSLAM by telephone and request a change of a configuration setting as desired.

However, the telephone line from the customer premise equipment side to the administrator company of the DSLAM might often be busy and it might take long time to connect to the administrator company. As a result, there was a problem in that the configuration setting of the DSLAM could not be reset or changed immediately when it was desired.

### SUMMARY OF THE INVENTION

It is an object of the present invention to provide a control system for an ADSL access multiplexer using an analog telephone signal that enables reset or change of a configuration setting of the DSLAM directly from the customer premise equipment side without involving an administrator company of the DSLAM.

In order to achieve the above object, the present invention provides a control system for station equipment comprising a controller that makes various configuration settings of the station equipment changeable in response to a special number that is sent from customer premise equipment.

It enables changing the various configuration settings of the xDSL access multiplexer directly from the customer premise equipment without involving the administrator company of the xDSL station equipment.

### BRIEF DESCRIPTION OF THE DRAWINGS

The above and other objects and features of the present invention will be more apparent from the following description of the embodiment with reference to the accompanying drawings, wherein like reference numerals indicate like elements throughout the several views, in which:

FIG. 1 is a block diagram showing a schematic configuration of a control system of xDSL access multiplexer using an analog telephone signal according to an embodiment of the present invention;

FIG. 2 is a block diagram showing the station equipment 2 shown in FIG. 1 in more detail;

FIG. 3 is a flow chart schematically describing operation of the control system for the xDSL access multiplexer using the analog telephone signal shown in FIG. 1 and 2;

FIG. 4 is a portion of a more detailed flow chart describing the operation shown in FIG. 3;

FIG. 5 is another portion of the more detailed flow chart describing the operation shown in FIG. 3;

FIG. 6 is still another portion of the more detailed flow chart describing the operation shown in FIG. 3; and

FIG. 7 is yet another portion of the more detailed flow chart describing the operation shown in FIG. 3.

### DESCRIPTION OF THE PREFERRED EMBODIMENT

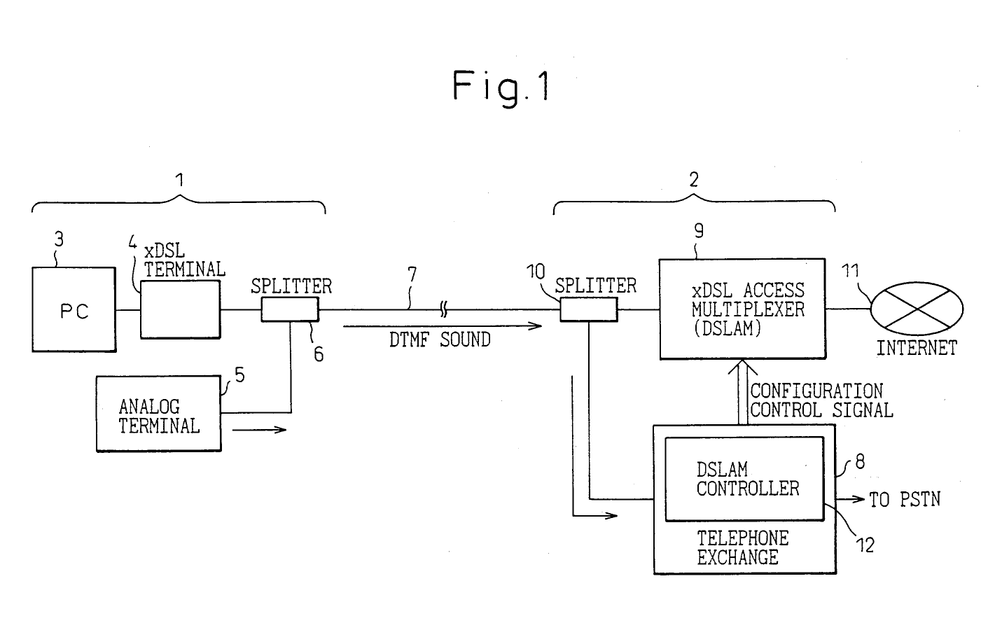

FIG. 1 is a block diagram showing a schematic configuration of a control system for xDSL station equipment using an analog telephone signal according to an embodiment of the present invention. In FIG. 1, the system comprises customer premise equipment 1 and station equipment 2. The customer premise equipment 1 comprises a personal computer (PC) 3, an xDSL terminal 4 that is connected to the PC 3, an analog terminal 5 that produces DTMF sound, and a splitter 6 that is connected to the xDSL terminal 4 and the analog terminal 5.

The station equipment 2 is connected to the customer premise equipment 1 via an analog line 7 and comprises a telephone exchange 8, an xDSL access multiplexer (hereinafter referred to as the DSLAM) 9, and a splitter 10.

The splitter 6 in the customer premise equipment 1 separates signals that are transmitted from the station equipment 2 via the analog line 7 in terms of frequency to supply the signals to the xDSL terminal 4 and the analog terminal 5, or combines the signals from the xDSL terminal 4 and the analog terminal 5 to supply to the station equipment 2 via the analog line 7.

The analog terminal 6 may be any apparatus that can produce DTMF sound, such as a telephone set or a built-in modem of the PC 3.

Though only one piece of customer premise equipment is shown in FIG. 1, it is to be noted that a plurality of customer premise equipment (not shown) is connected to the station equipment 2.

The DSLAM 9 is connected to the Internet 11, and the telephone exchange 8 is connected to a public switched telephone network (PSTN).

According to an embodiment of the present invention, the telephone exchange 8 comprises a controller 12, wherein the controller 12 supplies a configuration control signal to the DSLAM 9 in response to a special number expressed by the DTMF sound that is output from the analog terminal 5. It enables various configuration settings of the DSLAM 9 in the station equipment 2 to be changed from the analog terminal 5 in the customer premise equipment 1.

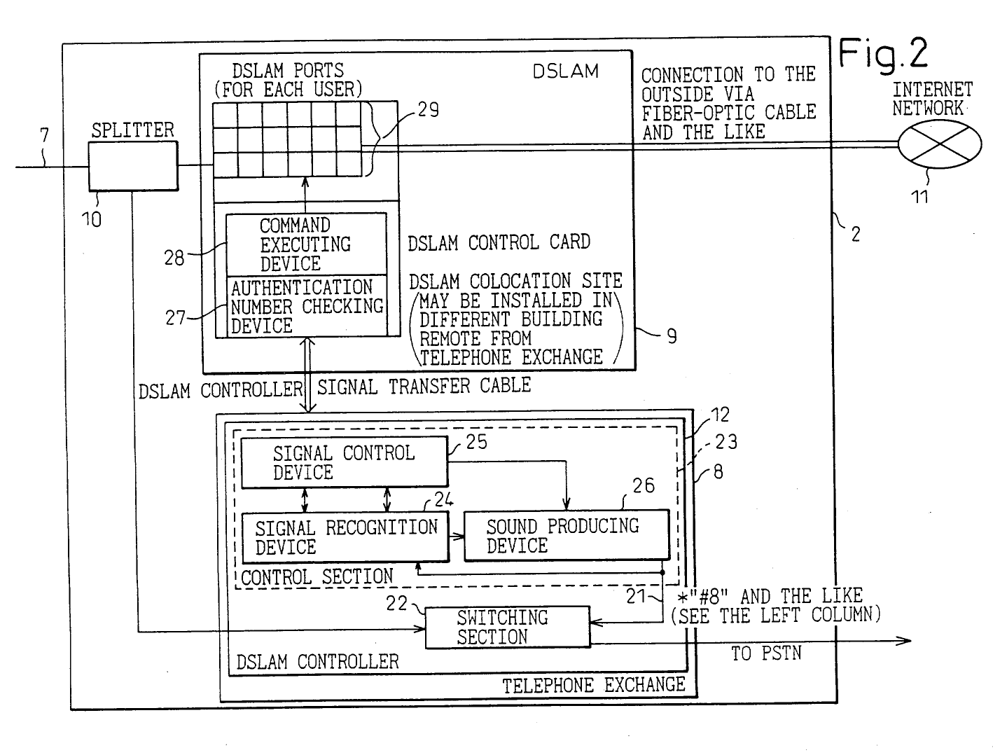

FIG. 2 is a block diagram showing the station equipment 2 in FIG. 1 in detail. In FIG. 2, the controller 12 comprises a switching section 22 that switches from the public switched telephone network (PSTN) to a control line 21 in response to a switching signal that is sent from the analog terminal 5 via the analog line 7 and the splitter 10, and a control section 23 that changes the various configuration settings stored in the DSLAM 9 according to a control signal that is sent from the analog terminal 5 via the control line 21 after the switching section 22 switches to the control line 21.

The control section 23 comprises a signal recognition device 24 that recognizes signal contents that are sent from the analog terminal 5 via the analog line 7, the splitter 10 and the switching section 22, a signal control device 25 that sends the control signal to the DSLAM 9 according to the contents recognized by the signal recognition device 24, and a sound producing device 26 that is connected to the signal recognition device 24 and the signal control device 25. The sound producing device 26 sends out an announcement that prompts a user to input a number to the analog terminal 5 in response to an instruction from the signal recognition device 24 after the switching to the control line 21 by the switching signal.

When the signal recognition device 24 recognizes the user number, it transmits the control signal that corresponds to the user number to the DSLAM 9 and, at the same time, controls the sound producing device 26 so that the sound producing device 26 makes an announcement that prompts the analog terminal 5 to enter the authentication number that is unique to the user according to control by the signal recognition device 24.

The DSLAM 9 comprises an authentication number checking device 27, a command executing device 28, and DSLAM ports 29 for each user. Here, it is to be noted that the DSLAM 9 may alternatively be installed in a different building that is remote from the telephone exchange 8. The authentication number checking device 27 holds authentication numbers of each user and checks the authentication number that is unique to the user and received via the controller 12 against the authentication numbers of each user it holds. If there is a match, the command executing device 28 brings one user port in the DSLAM ports 29 that corresponds to the authentication number into a controllable state, and the authentication number checking device 27 controls the sound producing device 26 via the signal control device 25 in order to allow the sound producing device 26 to make an announcement about the changeable configuration settings to the analog terminal 5 under control of the command executing device 28 so that the user can select the configuration setting that he or she wishes to change.

The announcement about the changeable configuration settings prompts the user to enter any of the numbers assigned to each configuration setting to be changed by pushing buttons on the telephone set.

When the selected number is entered from the analog terminal 5 in response to the announcement to prompt to enter any of the numbers assigned to each configuration setting, the command executing device 28 receives the entered number via the DSLAM controller 12 and the authentication number checking device 27 in the DSLAM 9 and changes the configuration setting of the one user port of the DSLAM ports 29 that corresponds to the authentication number according to the entered number.

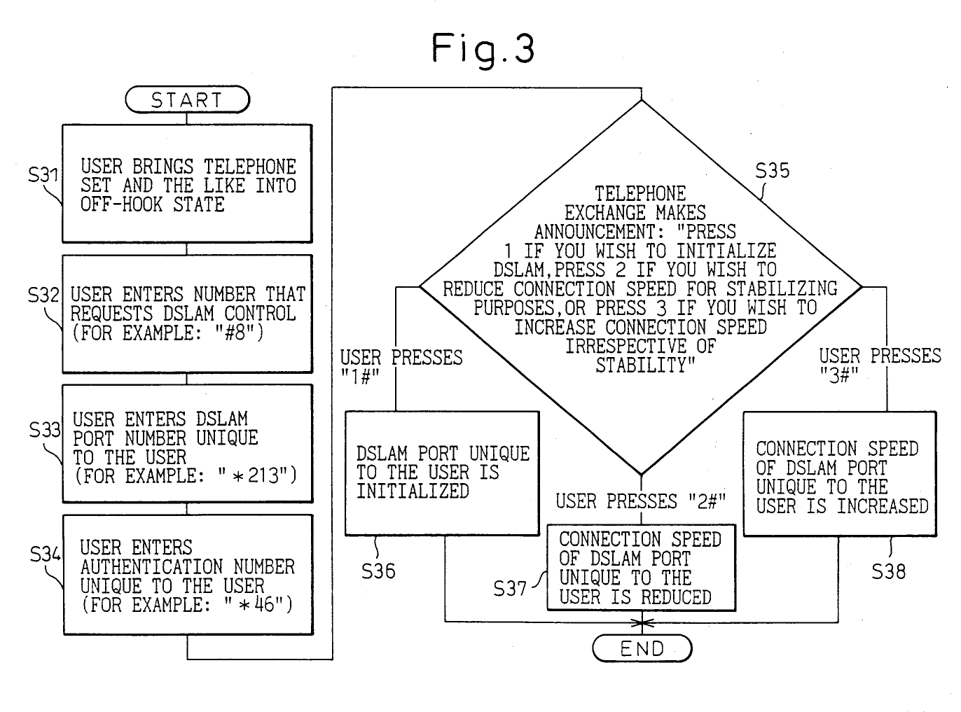

FIG. 3 is a flow chart schematically describing operation of the control system for the ADSL station equipment using the analog telephone signal shown in FIGS. 1 and 2. In FIG. 3, the user of the customer premise equipment 1 brings the analog terminal 5 such as a telephone set into an off-hook state in step S31. Then, the user enters a specific number (for example, “#8”) that requests control of the DSLAM 9 by pushing the buttons in step S32. Then, the user enters a DSLAM port number that is unique to the user (for example, “*213”) in step S33. Then, the user enters an authentication number that is also unique to the user (for example, “*46”) in step S34.

When these numbers reach the telephone exchange 8, the telephone exchange 8 transmits an announcement such as “press 1 if you wish to initialize the DSLAM, press 2 if you wish to reduce connection speed for stabilizing purposes, or press 3 if you wish to increase connection speed irrespective of stability” to the analog terminal 5 via the analog line 7. Upon hearing this announcement, if the user enters “1#”, the port of the DSLAM 9 that is unique to the user is initialized in step S36, if the user enters “2#”, the connection speed of the port of the DSLAM 9 that is unique to the user is reduced in step S37, or if the user enters “3#”, the connection speed of the port of the DSLAM 9 that is unique to the user is increased in step S38.

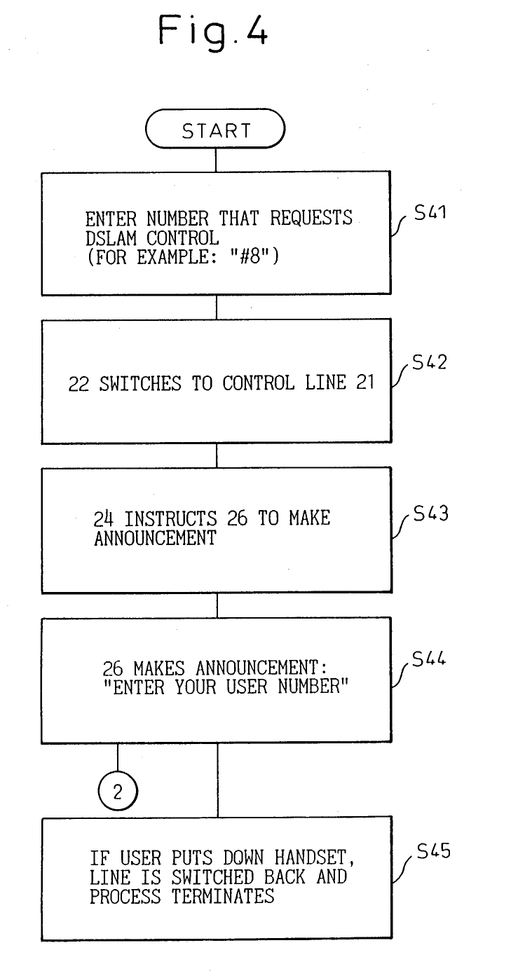

The flow chart of FIG. 3 is shown in more detail in FIG. 4 and later.

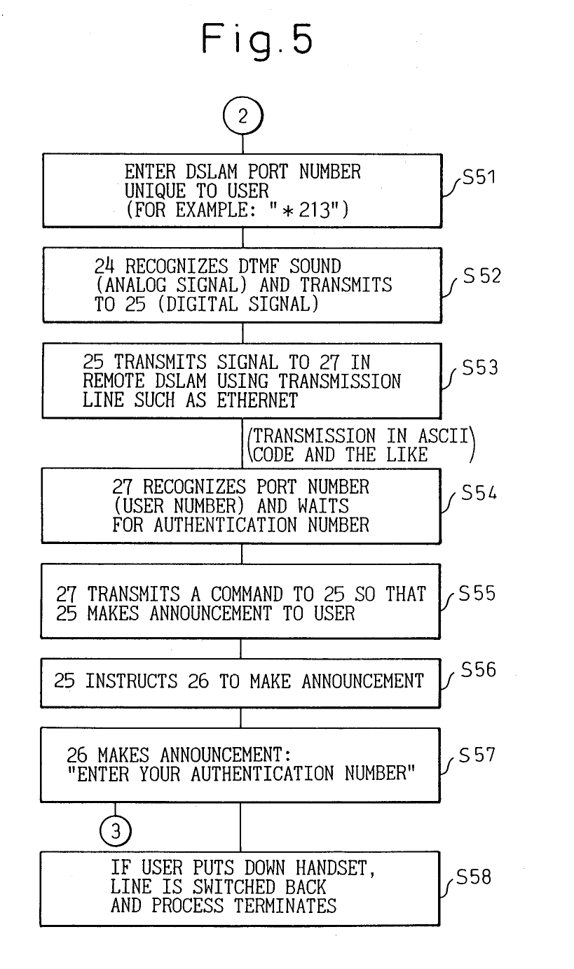

In step S41 of FIG. 4, the user enters a specific number (for example, “#8”) that requests control of the DSLAM 9 by pushing the buttons just as in step S32 of FIG. 3. Then, the switching section 22 switches from the PSTN to the control line 21 in step S42. Then, the signal recognition device 24 instructs the sound producing device 26 to make an announcement such as “enter your user number” in step S43. Then, the sound producing device 26 outputs the announcement “enter your user number” according to this instruction. This announcement reaches the analog terminal 5 via the analog line 7. After hearing this announcement, if the user puts down the handset of the analog terminal 5, the on-hook signal is transmitted to the switching section 22 so that the switching section 22 switches back to the PSTN to terminate the process. If the user does not bring the analog terminal 5 into the on-hook state, the process proceeds to the flow chart of FIG. 5.

In step S51 of FIG. 5, according to the announcement received at the analog terminal 5, the user enters a DSLAM port number that is unique to the user (for example, “*213”) just as in step S33 of FIG. 3. This number is transferred to the signal recognition device 24 via the analog line 7, the splitter 10 and the switching section 22 in the form of DTMF sound.

Then, in step S52, the signal recognition device 24 recognizes the DTMF sound of this number and converts it into a digital signal to be transferred to the signal control device 25.

Then, in step S53, the signal control device 25 transmits the digital signal in ASCII code and the like that corresponds to the above number to the authentication number checking device 27 that may be located remotely using a transmission line such as an Ethernet.

Then, in step S54, the authentication number checking device 27 recognizes the port number (the user number) based upon the received digital signal and waits for the authentication number.

Then, in step S55, the authentication number checking device 27 transmits a command to the signal control device 25 so that the signal control device 25 makes an announcement to the user.

Then, in step S56, the signal control device 25 instructs the sound producing device 26 to make an announcement such as “enter your authentication number”, for example.

Then, in step S57, the sound producing device 26 makes an announcement such as “enter your authentication number”, for example.

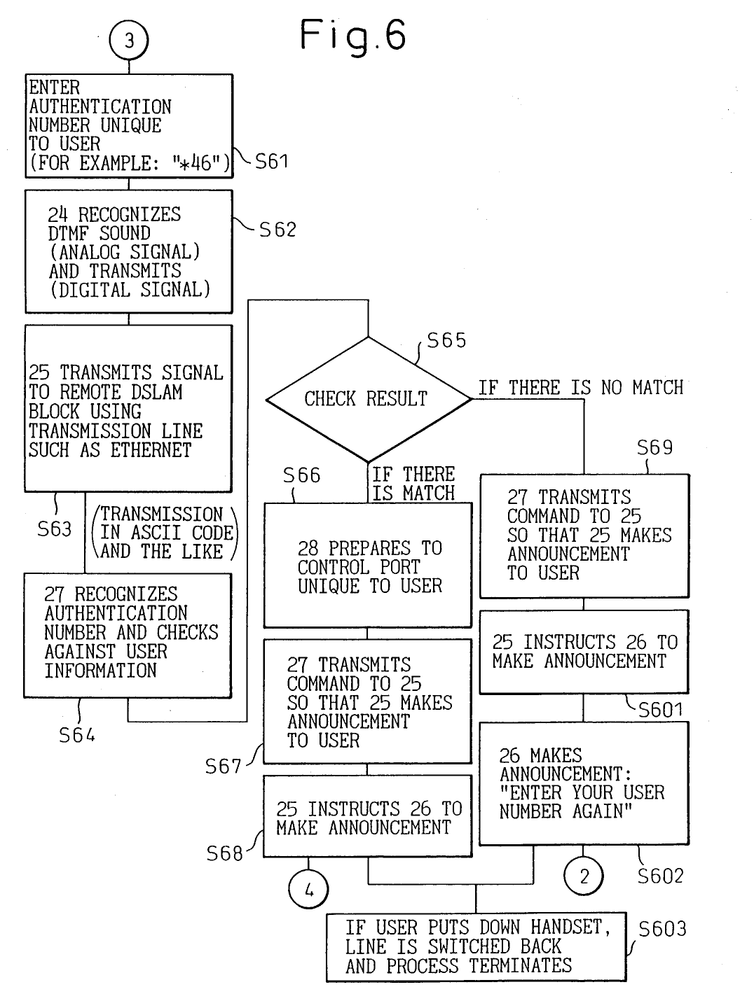

This announcement reaches the analog terminal 5 via the analog line 7. After hearing this announcement, if the user puts down the handset of the analog terminal 5, the on-hook signal is transmitted to the switching section 22 so that the switching section switches back to the PSTN to terminate the process. If the user does not bring the analog terminal t into the on-hook state, the process proceeds to the flow chart of FIG. 6.

In FIG. 6, the steps S61-S63 are same as the steps S51-S53 in FIG. 5, except that the authentication number (“*46”), not the DSLAM port number, is transferred in the form of DTMF sound.

Then, in step S64, the authentication number checking device 27 checks the received authentication number against the authentication numbers of each user it holds. If there is a match between the received authentication number and one of the held authentication numbers in step S65, the process proceeds to step S66, where the command executing device 28 prepares to control the port unique to the user.

Then, in step S67, the authentication number checking device 27 instructs the signal control device 25 to make an announcement such as, for example, “press 1 if you wish to initialize the DSLAM 9, press 2 if you wish to reduce connection speed for stabilizing purposes, or press 3 if you wish to increase connection speed irrespective of stability” to the user.

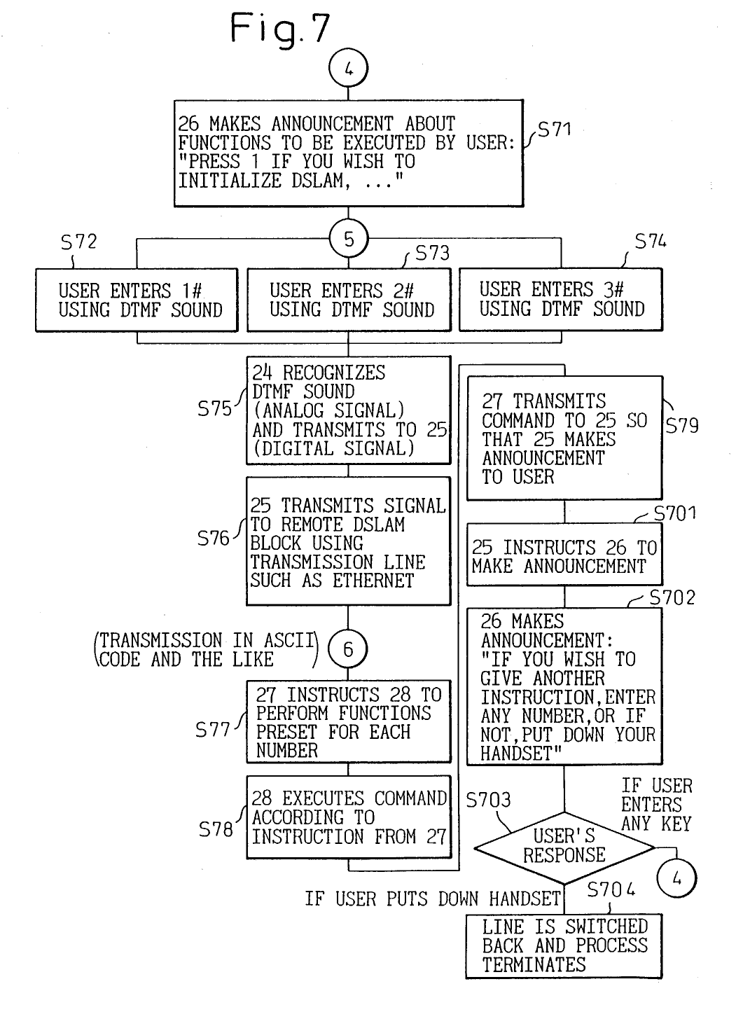

This announcement also reaches the analog terminal 5 via the analog line 7. After hearing this announcement, if the user puts down the handset of the analog terminal 5, the on-hook signal is transmitted to the switching section 22 so that the switching section 22 switches back to the PSTN to terminate the process. If the user does not bring the analog terminal 5 into the on-hook state, the process proceeds to the flow chart of FIG. 7.

If there is no match between the received authentication number and one of the held authentication numbers in step S65, the process proceeds to step S69, where the authentication number checking device 27 transmits a command to the signal control device 25 so that the signal control device 25 makes an announcement such as, for example, “enter your user number again” to the user.

Then, in step S601, the signal control device 25 instructs the sound producing device 26 to make the announcement mentioned above.

Then, in step S602, the sound producing device 26 makes the announcement such as, for example, “enter your user number again”.

This announcement also reaches the analog terminal 5 via the analog line 7. After hearing this announcement, if the user puts down the handset of the analog terminal 5, the on-hook signal is transmitted to the switching section 22 so that the switching section 22 switches back to the PSTN to terminate the process. If the user does not bring the analog terminal 5 into the on-hook state, the process returns to the flow chart of FIG. 5.

In FIG. 7, in response to the instruction in step S68 of FIG. 6, the sound producing device 26 makes an announcement such as, for example, “press 1 if you wish to initialize the DSLAM 9, press 2 if you wish to reduce connection speed for stabilizing purposes, or press 3 if you wish to increase connection speed irrespective of stability”.

In response to this announcement, if the user enters “1#”, the process proceeds to step S72, if the user enters “2#”, the process proceeds to step S73, or if the user enters “3#”, the process proceeds to step S74.

After any of the steps S72-S74, in steps S75-S76, the operation that is same as in the Steps S52-S53 of FIG. 5 is performed.

Then, in step S77, the authentication number checking device 27 instructs the command executing device 28 to perform functions that are preset for each DTMF sound number.

In step S78, the functions are performed according to the instruction from the authentication number checking device 27.

Then, in step S79, the authentication number checking device 27 transmits a command to the signal control device 25 so that the signal control device 25 makes an announcement such as, for example, “if you wish to give another instruction, enter any number, or if not, put down your handset” to the user.

In Step S701, the signal control device 25 instructs the sound producing device 26 to make the announcement mentioned above.

Then, in step S702, the sound producing device 26 makes the announcement mentioned above: “if you wish to give another instruction, enter any number, or if not, put down your handset”.

Then, the response of the user is determined in step S703, and then, if the user puts down the handset, the line is switched back to the PSTN and the process is terminated, or if the user enters any number, the process returns to step S71.

Though it is assumed that a telephone set is used as the analog terminal 5 in the embodiment described above, it is to be noted that a PC's built-in modem may be substituted for the telephone set.

As apparent from the above description, according to the present invention, there is provided a control system for xDSL access multiplexer using an analog telephone signal that enables reset or changing the configuration setting of a DSLAM directly from the customer premise equipment side without involvement of an administrator company of the DSLAM.

What is claimed is:

1. A control system for station equipment, comprising:
customer premise equipment; and
station equipment that comprises a telephone exchange connected to said customer premise equipment and for configuring communication conditions of said telephone exchange,
wherein said telephone exchange comprises a controller that makes corresponding one of various configuration settings of said station equipment changeable in response to a special number that is sent from said customer premise equipment.

2. A control system for an xDSL access multiplexer using an analog telephone signal, comprising:
customer premise equipment that comprises an xDSL terminal and an analog terminal that produces DTMF sound; and
station equipment that is connected to said customer premise equipment via an analog line and includes the xDSL access multiplexer for configuring xDSL communication conditions of an telephone exchange,
wherein said telephone exchange comprises a controller that makes various configuration settings of said telephone exchange in said xDSL access multiplexer changeable in response to DTMF sound that is sent from said analog terminal.

3. A control system for an xDSL access multiplexer according to claim 2, wherein said controller comprises a switching section that switches from a public switched telephone network to a control line in response to a switching signal that is sent from said analog terminal, and a control section that changes said various configuration settings that are set in said xDSL access multiplexer, after said switching section switches to said control line, according to a control signal that is sent from said analog terminal via said control line.

4. Station equipment that comprises a telephone exchange that is connected to customer premise equipment via an analog line and for configuring communication conditions of said telephone exchange,
wherein said telephone exchange comprises a controller that makes a corresponding one of various configuration settings of said station equipment changeable in response to a special number that is sent from said customer premise equipment..

5. Station equipment that is connected to customer premise equipment via an analog line and includes an xDSL access multiplexer for configuring xDSL communication conditions of a telephone exchange,
wherein said telephone exchange comprises a controller that makes various configuration settings, of said telephone exchange in said xDSL access multiplexer, changeable in response to DTMF sound that is sent from said analog terminal.
